(19) United States
(12) Patent Application Publication
(10) Pub. No.: US 2008/0252841 A1
(43) Pub. Date: Oct. 16, 2008

(54) LIQUID CRYSTAL DISPLAY

(75) Inventors: Katsuyuki Funahata, Hitachi (JP); Kiyosi Satou, Hitachi (JP); Kotaro Araya, Hitachiota (JP); Yasushi Tomioka, Hitachinaka (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(73) Assignee: Hitachi Chemical Company, ltd.

(21) Appl. No.: 12/099,797

(22) Filed: Apr. 9, 2008

(30) Foreign Application Priority Data
Apr. 11, 2007 (JP) 2007-103956

(51) Int. Cl. G02F 1/1339

(52) U.S. Cl. 349/155; 349/187

(57) ABSTRACT

A spacer includes a spacer seat formed on an array substrate and a spacer member formed on the spacer seat. A front end of the spacer member is a curved surface. The spacer seat is formed during a process for producing the array substrate. The spacer member is formed by a reverse printing or inkjet process.

### BACKGROUND OF THE INVENTION

The present invention relates to a liquid crystal display, particularly to a structure and producing method of a spacer of a liquid crystal panel.

A liquid crystal panel to be used in a liquid crystal display includes an array substrate including an active element for driving pixel electrodes, a color filter substrate including a color filter and black-matrix, and a liquid crystal between the substrates. A spacer is arranged between the array substrate and the color filter substrate so that a distance between the substrates, that is, a panel gap is kept constant.

In an example disclosed by JP-A-2005-345819, the spacer is formed on the color filter substrate. This spacer is arranged by a photolithography at a desired position on the color filter substrate with desired shape and density.

In an example disclosed by JP-A-2006-267524, the spacer is formed o the array substrate with utilizing the color filter and the color filter member.

On the other hand, JP-A-2001-56405 discloses a method for producing the color filter with utilizing a reverse printing.

### BRIEF SUMMARY OF THE INVENTION

In a case where the spacer is formed on the color filter substrate as disclosed by JP-A-2005-345819, there is a problem of that a positioning accuracy needs to be high when adhering the color filter substrate and the array substrate to each other, and whereby such operation is extremely difficult.

Therefore, the method for producing the spacer on the array substrate including the active element with utilizing the color filter and the color filter member as disclosed by JP-A-2006-267524 is thought of. However, in the method disclosed by JP-A-2006-267524, there is a problem of that process steps of the photolithography is increased to deteriorate significantly process yield.

An object of the present invention is to provide a liquid crystal display of high image quality without a necessity of high positioning accuracy when adhering the array substrate and the substrate opposed thereto.

According to the invention, in the liquid crystal display, the spacer includes a spacer seat formed on the array substrate and a spacer member formed on the spacer seat. A front end of the spacer member has a curved surface.

The spacer seat is formed during a process for forming the array substrate. That is, it is formed by the photolithography during the process for forming the array substrate. On the other hand, the spacer member is formed by the reverse printing or ink-jet.

By the invention, the liquid crystal display of high image quality can be provided without the necessity of high positioning accuracy when adhering the array substrate and the substrate opposed thereto.

Other objects, features and advantages of the invention will become apparent from the following description of the embodiments of the invention taken in conjunction with the accompanying drawings.

### BRIEF DESCRIPTION OF THE SEVERAL VIEWS OF THE DRAWINGS

FIG. 1a is an upper view of a liquid crystal panel of the invention.

FIG. 1b is a cross sectional view of array substrate of the liquid crystal panel of the invention.

FIG. 1c is a cross sectional view of the liquid crystal panel of the invention.

FIG. 2 is a cross sectional view of a spacer member of the liquid crystal panel of the invention.

FIG. 3 includes views showing a first embodiment of process for producing the spacer member of the liquid crystal panel of the invention.

FIG. 4 includes views showing a second embodiment of process for producing the spacer member of the liquid crystal panel of the invention.

FIG. 5 includes views showing a third embodiment of process for producing the spacer member of the liquid crystal panel of the invention.

FIG. 6 includes views showing a fourth embodiment of process for producing the spacer member of the liquid crystal panel of the invention.

FIG. 7 includes views showing a fifth embodiment of process for producing the spacer member of the liquid crystal panel of the invention.

### DETAILED DESCRIPTION OF THE INVENTION

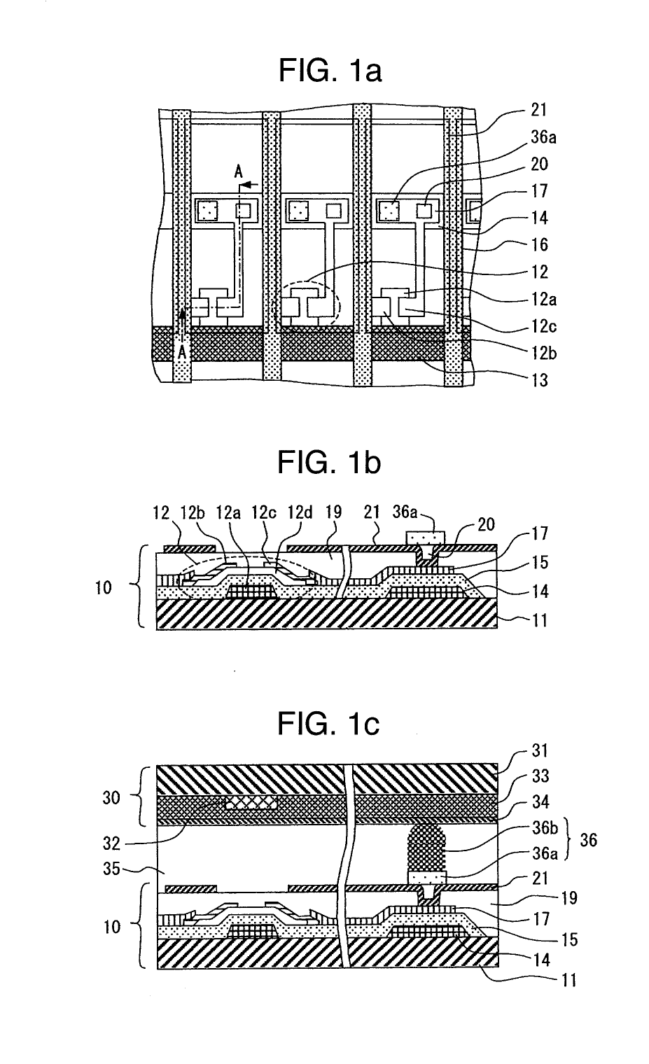

A liquid crystal display as an embodiment of the invention is described with making reference to FIGS. 1a-1c. FIG. 1a shows schematically a structure of pixel electrodes of an array substrate of an active matrix type liquid crystal panel as the embodiment, and FIG. 1b is a cross sectional view taken along line Ia-Ia in FIG. 1a. FIG. 1c is a cross sectional view of the active matrix type liquid crystal panel as the embodiment.

As shown in FIG. 1c, the liquid crystal panel of the embodiment includes the array substrate 10, an opposed substrate 30 and a liquid crystal arranged between the substrate. A spacer 36 of column shape is arranged between the array substrate 10 and the opposed substrate 30. The spacer 36 includes a spacer seat 36a and a spacer member 36b.

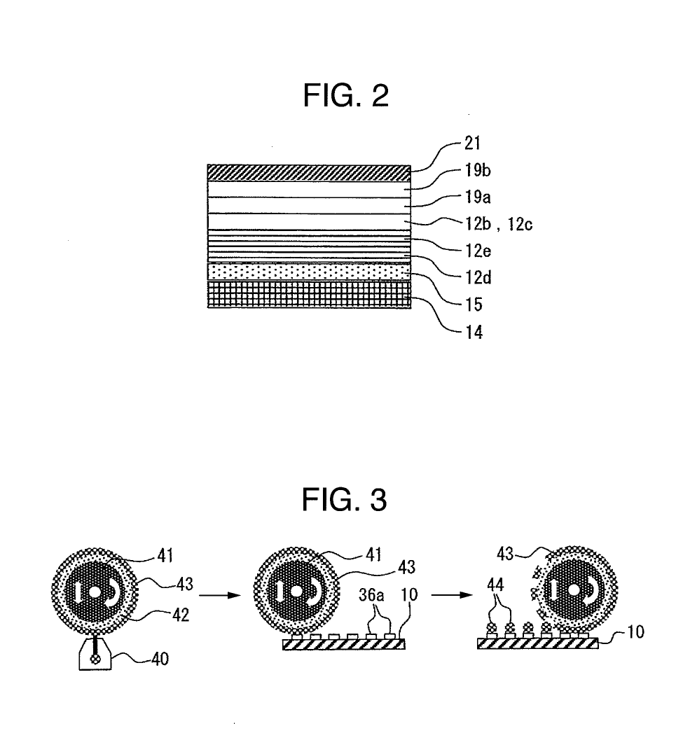

As shown in FIG. 1c, the opposed substrate 30 includes a glass substrate 31, a light shielding layer 32, a color filter 33 and an opposed electrode 34. The array substrate 10 includes a glass substrate 11, an accumulated capacitance bus line 14, a gate insulating film 15, accumulated capacitance electrodes 17, an insulating protector film 19 and pixel electrodes 21. As shown inn FIG. 1b, the array substrate includes active elements 12. Each of the active elements has a gate electrode 12a, a source electrode 12b, a drain electrode 12c, an a-Si layer 12d and a n⁺a-Si layer 12e (FIG. 2).

Each of the pixel electrodes 21 is electrically connected to the accumulated capacitance electrode 17 through a contact hole 20 formed in the insulating protector film 19. The accumulated capacitance electrode 17 is electrically connected to the drain electrode 12c of the active element 12.

As shown in FIG. 1a, in the embodiment, the spacer seat 36a is arranged on the accumulated capacitance electrode 17. That is, the spacer 36 is arranged on each of the pixel electrodes 21. As shown in FIG. 1c, in the embodiment, the spacer 36 is arranged to face to the color filter 33 of the opposed substrate 30. Further, the spacer 36 is arranged preferably at a position facing to a light shielding part of the color filter or a part of blue or red color filter part of low visibility so that an affect of orientation error of the liquid crystal caused by positional error or the like during adhering the array substrate 10 and the opposed substrate 30 to each other is restrained. Therefore, the liquid crystal panel can achieve the high image quality even when the liquid crystal panel has a large display size and a cost for producing the liquid crystal panel is decreased.

Incidentally, an arrangement or density of the spacers may be modified variously in accordance with the size or intended use of the liquid crystal panel without being limited to the embodiment shown in FIG. 1a.

As shown in FIG. 1c, the front end of the spacer member 36b is not flat, but curved. In the embodiment, the front end of the spacer member 36b may be semi-spherical or curved as occasion demands. Further, the front end or whole of the spacer member 36b is made of an elastically deformable resin.

A method for producing the liquid crystal panel of the invention is described briefly. At first, a method for producing the array substrate 10, particularly a method for producing the spacer seat 36a is described. At first, a gate layer is formed by sputtering on the glass substrate 11. Next, a patterning is performed to form a gate bus line 13, a gate electrode 12a, and the accumulated capacitance bus line 14.

Subsequently, a gate insulating layer 15 is formed by CVD method, and a data bus line 16, a source electrode 12b, a drain electrode 12c, an accumulated capacitance electrode 17 and a bottom part of the spacer seat 36a is formed thereon. Incidentally, the formed bottom part of the spacer seat 36a is a flat protrusion of 15 microns square.

Subsequently, the insulating protector layer 19 is formed, a transparent electrically conductive film is formed by the sputtering, and the patterning is performed to form the spacer seat 36a. As shown in FIG. 1c, the spacer seat 36a higher than height of the pixel electrode 21 and the active elements 12 is formed. Finally, an orientation film is formed to cover the whole of the display area.

As described above, in the embodiment, the spacer seat 36 is formed through the process for producing the array substrate 10. That is, the spacer seat 36 is not formed through an additional process for forming only the spacer seat 36, but is formed by the photolithography for forming the array substrate. In such process, the spacer seat 36a higher than height of the pixel electrode 21 and the active elements 12 is formed.

Subsequently, the spacer member 36b is formed on the spacer seat 36a. According to the invention, as a method for producing the spacer member 36b, the reverse printing or ink-jet printing is used. The reverse printing uses a principle of reverse printing. The reverse printing and ink-jet printing will be described below in detail.

In the embodiment, since the height of the spacer seat 36a is higher than the heights of the pixel electrode 21 and the active element 12, the reverse printing utilizing a transfer roller may be used.

In the embodiment, the height of the spacer 36 is 4 microns to be equal to a thickness of the liquid crystal. Further, the height of the spacer seat 36a is 1.0-3.0 microns, and the height of the spacer member 36b is 1.0-3.0 microns. A stiffness of the spacer seat 36a is not less than a stiffness of the spacer member 36b. When the stiffness of the spacer member 36b is low, the height of the spacer seat 36a is increased to decrease the height of the spacer member 36b. When the stiffness of the spacer member 36b is sufficiently high, the height of the spacer seat 36a may be decreased to increase the height of the spacer member 36b.

Subsequently, the opposed substrate 30 is formed. The light shield layer 32 is formed on the glass substrate 31, and the color filter 33 is formed thereon. The opposed electrode 34 is formed thereon. The oppose electrode 34 is formed over the whole of the area where the pixels are formed. By forming the orientation film on the opposed electrode 34, the opposed substrate 30 is formed.

Finally, an adhesive layer and the liquid crystal layer are formed on at least one of the array substrate 10 on which the spacer seat 36a and the spacer member 36b are formed and the opposed substrate, and the substrates are adhered to each other to form the liquid crystal panel.

According to the invention, the front end of the spacer 36 is curved and made of the elastic material. Therefore, the opposed substrate and the array substrate do not need to be positioned accurately when being adhered to each other. Therefore, the opposed substrate and the array substrate can be adhered to each other easily to improve an operating efficiency.

Further, according to the invention, the accuracy and evenness in size of the spacer are improved by a simplified mask-less alignment-free method without increase in man power for the photolithography. Therefore, the accuracy and evenness in thickness of the liquid crystal most important for the liquid crystal panel are obtained to achieve the high image quality.

Further, the liquid crystal panel of the invention characterized by the spacer for defining the thickness of the liquid crystal layer is applicable to any type of liquid crystal such as IPS, MVA, ECB and so forth.

FIG. 2 shows the structure of the spacer seat 36a. The spacer seat 36a includes the accumulated capacitance bus line 14, the gate insulating film 15, the a-Si layer 12d, the n⁺a-Si layer 12e, the source electrode 12b, the drain electrode 12c, the non-organic insulating layer 19a, the organic insulating layer 19a and the pixel electrode 21. That is, the spacer seat 36a is a stack of the active element and the pixel electrode.

Next, with making reference to FIG. 3, a first embodiment of method for producing the spacer member for the liquid crystal panel of the invention is described. In this embodiment, the reverse printing and a slit coater process are used. The height of the spacer seat 36a is 1.5 microns, and the height of the spacer member 36b is 2.5 microns. As shown in left part of FIG. 3, a transfer roller 41 including a silicone ink-repellent blanket 42 is prepared. A coating film forming device 40 such as a slit coater or the like is used to form a resin film 43 on a surface of the transfer roller 41. The resin film 43 has an amount for forming the spacer member 36b having the height of 2.5 microns. Subsequently, as shown in central part of FIG. 3, the array substrate 10 including the spacer seat 36a having the height of 1.5 microns is prepared. The transfer roller 41 is rolled on the array substrate 10 to make the resin film 43 on the transfer roller 41 contact the spacer seat 36a on the array substrate 10. Therefore, as shown in right part of FIG. 3, the resin layer 43 is transferred from the transfer roller 41 onto the spacer seat 36a on the array substrate 10 to form a resin droplet 44. The resin droplet 44 with surface tension forms a curved surface of predetermined curvature on the spacer seat 36a. The resin droplet 44 is cured to form the spacer member 36b having the front end of curved surface.

The resin of the spacer member is described hereafter. For the reverse printing, a rubber type resin or novolac resin and a volatile solvent as a mixture of quick-drying organic solvent and slow-drying organic solvent are needed. The resin and the volatile solvent are mixed with each other to form a resin solution. By adjusting a physical property values such as viscosity, surface tension and so forth of the resin solution, a surface energy of the spacer seat 36a and a condition of printing process such as a rotational speed of the transfer roller 41 and so forth, the front end of the spacer member 36b can have a desired curvature of the surface.

As the rubber type resin, acrylic rubber type resin, silicone rubber type resin, EPDM rubber type resin or the like is usable. As the novolac resin, cresol type resin, resole type resin or the like is usable. As the quick-drying organic solvent, ester type solvent such as ethyl acetate, isopropyl acetate or the like, alcohol type solvent such as methyl alcohol, ethyl alcohol or the like, or hydrocarbon type solvent such as toluene, xylene or the like, is usable. As the slow-drying organic solvent, ester type solvent such as propylene glycol monomethyl ether acetate, 3-methoxy-3-methyl-butylacetate, ethoxyethylpropoinate, isoamyl acetate or the like is usable. Incidentally, the invention should not be limited to these materials.

It is preferable in the light of a tolerance in thickness of the liquid crystal and a margin for producing the liquid crystal panel that the resin as the material of the spacer member 36b has high compression modulus of elasticity.

Further, it is preferable that the resin solution has the viscosity of 0.5-20 mPa·s and the surface tension of 20-28 dyn/cm, the ink-repellent blanket of the transfer roller has a critical surface tension of 24-34 dyn/cm.

Further, it is preferable that the viscosity, surface tension and so forth as the characteristics of the resin solution is adjusted to have desired values by adjusting a concentration of the resin and a mixing ratio of the volatile solvent between the quick-drying solvent and the slow-drying solvent.

In this embodiment, by a simple process without using a printing plate and an alignment thereof, the spacer member 36b having the front end of the curved surface of the predetermined curvature can be formed.

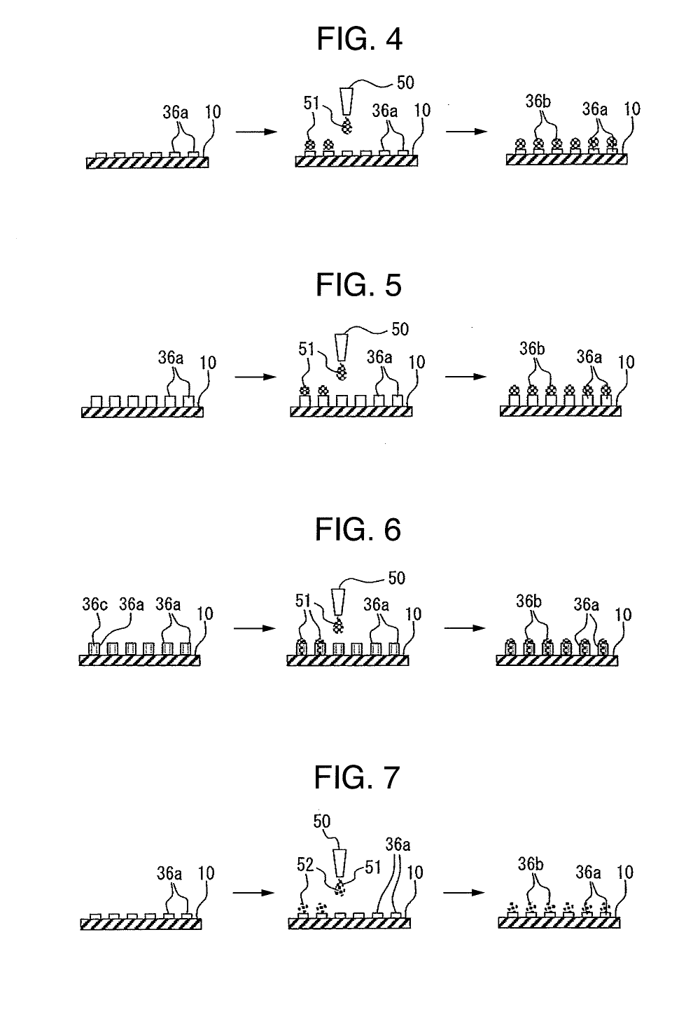

With making reference to FIG. 4, a second embodiment of method for producing the spacer member for the liquid crystal panel of the invention is described. In this embodiment, the ink-jet process is used. The height of the spacer seat 36a is 1.5 microns, and the height of the spacer member 36b is 2.5 microns.

A left part of FIG. 4 shows the array substrate 10 including the spacer seat 36a having the height of 1.5 microns. As shown in central part of FIG. 4, a spacer forming device 50 supplies with the ink jet process a resin droplet 51 onto the spacer seat 36a of the array substrate 10. The resin droplet 51 has an amount for forming the spacer member 36b having the height of 2.5 microns. The resin droplet 51 on the spacer seat 36a forms the curved surface of the predetermined curvature with its surface tension. As shown in right part of FIG. 4, the resin droplet 51 is cured to form the spacer member 36b having the front end of the curved surface. The height of the spacer member 36b and the shape of the front end of the curved surface are changed by adjusting the surface tension and viscosity of the resin, and/or by adjusting surface energies of the resin and the spacer seat, for example, affinity of the resin for the spacer seat or the like.

When using the ink jet process, it is preferable for the resin solution to have the viscosity of 0.5-10 mPa·s and the surface tension of 25-35 dyn/cm. Further, as the solvent of the resin solution, in the light of drying property, the slow-drying solvent is preferably used.

In comparing the method for forming the spacer member of this embodiment and the method for forming the spacer member with the reverse printing as shown in FIG. 3 with each other, the method of this embodiment is inferior in the evenness of the height of the spacer members and a time period for forming the spacer members to the method shown in FIG. 3. On the other hand, in comparing the liquid crystal panel including the spacer formed by this embodiment and the prior art liquid crystal panel including the spacer formed on the opposed substrate having the color filter, the liquid crystal panel formed by the method of this embodiment is superior in image quality and cost to the prior art liquid crystal panel.

With making reference to FIG. 5, a third embodiment of method for producing the spacer member for the liquid crystal panel of the invention is described. In this embodiment, the ink-jet process is used. The height of the spacer seat 36a is 2.5 microns, and the height of the spacer member 36b is 1.5 microns.

A left part of FIG. 5 shows the array substrate 10 including the spacer seat 36a having the height of 2.5 microns. The height of the spacer seat 36a of this embodiment is higher than that of the second embodiment. As shown in central part of FIG. 5, the spacer forming device 50 supplies with the ink jet process the resin droplet 51 onto the spacer seat 36a of the array substrate 10. The resin droplet 51 has an amount for forming the spacer member 36b having the height of 1.5 microns. The resin droplet 51 on the spacer seat 36a forms the curved surface of the predetermined curvature with its surface tension. As shown in right part of FIG. 5, the resin droplet 51 is cured to form the spacer member 36b having the front end of the curved surface. The height of the spacer member 36b and the shape of the front end of the curved surface are changed by adjusting the surface tension and viscosity of the resin, and/or by adjusting surface energies of the resin and the spacer seat, for example, affinity of the resin for the spacer seat or the like.

In comparing the method for forming the spacer member with the ink jet process of this embodiment and the method for forming the spacer member with the ink jet process as shown in FIG. 4, the height of the spacer member in this embodiment is lower than that in the second embodiment. The inkjet process is inferior in accuracy of formed film to the reverse printing. Particularly, when the height of the spacer member is great, it is difficult for the height of the spacer member 36b to be formed in high accuracy. Since the height of the spacer is small, the accuracy of the height of the spacer member 36b is high. Therefore, the evenness in the thickness of the liquid crystal is improved to make the liquid crystal panel superior in image quality to the liquid crystal panel formed by the method as shown in FIG. 4.

In this embodiment, the height of the spacer seat 36a is 2.5 microns, and the height of the spacer member 36b is 1.5 microns, but a ratio between the height of the spacer seat 36a and the height of the spacer member 36b should not be limited to this embodiment.

With making reference to FIG. 6, a fourth embodiment of method for producing the spacer member for the liquid crystal panel of the invention is described. In this embodiment, the ink-jet process is used. The height of the spacer seat 36a is 2.5 microns, and the height of the spacer member 36b is 1.5 microns. In the embodiment, the front end of the spacer seat 36a has a concave shape, or the spacer seat 36a has a cylindrical shape.

A left part of FIG. 6 shows the array substrate 10 including the spacer seat 36a having the height of 2.5 microns. The height of the spacer seat 36a of this embodiment is greater than that of the second embodiment as shown in FIG. 4, and is equal to that of the third embodiment as shown in FIG. 5. As shown in central part of FIG. 6, the spacer forming device 50 supplies with the ink jet process the resin droplet 51 onto the spacer seat 36a of the array substrate 10. The resin droplet 51 has an amount for forming the spacer member 36b having the height of 1.5 microns. The resin droplet 51 on the spacer seat 36a forms the curved surface of the predetermined curvature with its surface tension. As shown in right part of FIG. 6, the resin droplet 51 is cured to form the spacer member 36b having the front end of the curved surface. The height of the spacer member 36b and the shape of the front end of the curved surface are changed by adjusting the surface tension and viscosity of the resin, and/or by adjusting surface energies of the resin and the spacer seat, for example, affinity of the resin for the spacer seat or the like.

In comparing the method for forming the spacer member in this embodiment and the method for forming the spacer member with the reverse printing as shown in FIG. 3, the method of this embodiment is inferior in the evenness of the height of the spacer members and the time period for forming the spacer members to the method as shown in FIG. 3. In comparing the method for forming the spacer member in this embodiment and the method for forming the spacer member as shown in FIG. 5, since a variation in amount of the resin droplet forming the spacer member is restrained in this embodiment, the evenness of the height of the spacer members is improved. Therefore, the liquid crystal panel including the spacer formed in this embodiment is superior in image quality and cost to the prior art liquid crystal panel including the spacer formed on the opposed substrate having the color filter.

With making reference to FIG. 7, a fifth embodiment of method for producing the spacer member for the liquid crystal panel of the invention is described. In this embodiment, the ink-jet process is used. The height of the spacer seat 36a is 1.5 microns, and the height of the spacer member 36b is 2.5 microns. In the embodiment, the solution of low resin concentration in which polymer beads 52 are dispersed is used. The polymer beads 52 are spherical resin fine grains made of benzoguanamine melamine formic aldehyde condensation product, melamine formic aldehyde condensation product, polymethacrylic acid methyl type crosslinked resin or the like, and have an average grain diameter of 2.5-3 microns. Incidentally, as the polymer beads 52, organic/inorganic hybrid fine grains or inorganic spherical fine grains may be used as substitute for the spherical resin fine grains. As the resin solution, acrylic rubber type resin solution of 5-10 wt % may be used.

Left part of FIG. 7 shows the array substrate including the spacer seat 36a having the height of 1.5 microns. As shown by central part of FIG. 7, the spacer forming device 50 supplies with the ink jet process the resin droplet including the polymer beads 52 onto the spacer seat 36a of the array substrate 10. Therefore, one of the polymer beads 52 is arranged on the spacer seat 36a. As shown by right part of FIG. 7, the volatile solvent is vaporized to dry the resin solution so that the polymer bead is fixed to the spacer seat 36a. Therefore, the spacer member 36 whose front end is the curved surface is formed. The height of the spacer seat 36a is 1.5 microns, and the diameter of the polymer bead 52 is 2.5-3 microns. Therefore, the spacer 36 has the height of 4.0-4.5 microns.

The height and shape of the front end of the spacer member 36b may be changed by changing the diameter of the polymer bead 52. The stiffness and elasticity of the spacer member 36b depend on the stiffness and elasticity of the polymer bead 52. By using the polymer bead 52 as the resin spherical fine grain of high compression modulus, the stiffness and elasticity of the spacer member 36b is kept.

In comparing the method for forming the spacer member in this embodiment and the method for forming the spacer member with the reverse printing as shown in FIG. 3 with each other, the method of this invention is slightly inferior in the evenness of the height of the spacer members and the time period for forming the spacer members to the method shown in FIG. 3. In comparing the method for forming the spacer member in this embodiment and the method for forming the spacer member as shown in FIG. 4 with each other, the method of this invention is superior in the stiffness and elasticity of the spacer member to the method shown in FIG. 4. Therefore, the liquid crystal panel formed by the method of this embodiment is superior in the image quality and the cost to the prior art liquid crystal panel in which the spacer is formed on the opposed substrate including the color filter.

The invention is described with making reference to the above embodiments, but it is readily thought of that the invention is not limited to the above embodiments, but can be modified variously in the scope defined by the claims.

The liquid crystal panel of the invention is applicable to a display for a TV set, a desktop computer or the like. Further, the liquid crystal panel of the invention is applicable to a high quality liquid crystal display for a car navigation system or mobile equipment such as mobile phone or the like, or a liquid crystal display of relatively great size.

It should be further understood by those skilled in the art that although the foregoing description has been made on embodiments of the invention, the invention is not limited thereto and various changes and modifications may be made without departing from the spirit of the invention and the scope of the appended claims.

1. A liquid crystal panel comprising first and second substrates opposed to each other, a liquid crystal arranged between the first and second substrates in sealed manner, and a spacer arranged between the first and second substrates,
wherein the first substrate includes active elements, wirings, pixel electrodes, spacer seats and spacer members arranged on the spacer seats,
the spacer member and the spacer seat form the spacer, and the spacer member is opposed to a color filter formed on the second substrate.

2. The liquid crystal panel according to claim 1, wherein a front end of the spacer member is a curved surface.

3. The liquid crystal panel according to claim 1, wherein heights of the spacer seat are higher than heights of the active elements.

4. The liquid crystal panel according to claim 1, wherein the spacer seats are formed on the wirings.

5. The liquid crystal panel according to claim 1, wherein the spacer seat includes materials of the active element, the wiring and the pixel electrode.

6. The liquid crystal panel according to claim 1, wherein a stiffness of the spacer seat is not less than a stiffness of the spacer member.

7. The liquid crystal panel according to claim 1, wherein the spacer member is includes a rubber type resin or novolac resin.

8. The liquid crystal panel according to claim 7, wherein the spacer member includes a fine bead.

9. A liquid crystal display comprising the liquid crystal panel according to claim 1, and a driver connected to the liquid crystal panel to drive the liquid crystal panel.

10. A method for producing a liquid crystal comprising the steps of:
an array substrate producing step in which active elements, wirings, pixel electrodes and spacer seats are formed on a substrate,
a spacer member producing step in which spacer members are formed on the spacer seats,
an opposed substrate producing step in which an opposed electrode is formed over the whole of a pixel forming area on another substrate to form an opposed substrate, and
a substrate arranging step in which the array substrate and the opposed substrate are arranged to be opposed to each other through spacers composed of the spacer seats and the spacer members with a liquid crystal between the array substrate and the opposed substrate.

11. The method according to claim 10, wherein the spacer member producing step includes:
forming a film of resin on a surface of a transfer roller,
rolling the transfer roller on the array substrate including the spacer seats to transfer the resin from the transfer roller onto the spacer seats, and
curing the resin on the spacer seats.

12. The method according to claim 10, wherein the spacer member producing step includes:
supplying a droplet of resin with inkjet process onto the spacer seats, and
curing the resin on the spacer seats.

13. The method according to claim 12, wherein upper ends of the spacer seats are concave surfaces.

14. The method according to claim 12, wherein the resin includes a fine bead.

15. A liquid crystal display comprising an array substrate including active elements and pixel electrodes, an opposed substrate including a color filter, a liquid crystal arranged between the array substrate and the opposed substrate in sealed manner, spacers arranged between the array substrate and the opposed substrate,
wherein the each of the spacers includes a spacer seat formed on the array substrate and a spacer member formed on the spacer seat, and a front end of the spacer member is a curved surface.

16. The liquid crystal display according to claim 15, wherein the spacers are arranged to oppose to the color filter.

17. The liquid crystal display according to claim 15, wherein a height of the spacer seat is greater than heights of the active elements.

18. The liquid crystal display according to claim 15, wherein the spacer member is made of an elastic material.
